(19) United States
(12) Patent Application Publication
(10) Pub. No.: US 2022/0281211 A1
(43) Pub. Date: Sep. 8, 2022

(54) ENVIRONMENTALLY FRIENDLY SCREEN PROTECTOR

(71) Applicant: NLU Products, L.L.C., Lehi, UT (US)

(72) Inventor: Jordan Melville, Sandy, UT (US)

(21) Appl. No.: 17/190,174

(22) Filed: Mar. 2, 2021

(51) Int. Cl. B32B 27/08; B32B 27/30; B32B 7/12; B32B 27/28; B32B 27/36

(52) U.S. Cl. CPC B32B 27/08; B32B 27/308; B32B 7/12; B32B 27/283; B32B 27/36; B32B 2250/244; B32B 2250/05; B32B 2255/28; B32B 2255/10; B32B 2307/412; B32B 2307/558; B32B 2307/584; B32B 2457/20

(57) ABSTRACT

A synthetic glass screen protector apparatus may include a polymethyl methacrylate (PMMA) layer. The apparatus may further include an A-B glue layer, where the A-B glue layer includes an optically clear adhesive sub-layer and a silicone adhesive sub-layer, and where the clear adhesive sub-layer is in direct contact with the silicone adhesive sub-layer, omitting any polyethylene terephthalate (PET) layer therebetween. A method for forming a synthetic glass screen protector apparatus may include forming an A-B glue layer by positioning an optically clear adhesive sub-layer in direct contact with a silicone adhesive sub-layer and attaching the A-B glue layer to a PMMA layer.

### FIELD OF THE DISCLOSURE

This disclosure is generally related to the field of screen protectors for mobile devices and, in particular, to environmentally friendly screen protectors.

### BACKGROUND

As mobile devices, such as cell phones, tablets, and other carriable electronic devices become more predominant worldwide, the amount of waste associated with such mobile devices, and their accessories, may also increase. As an example, screen protectors may contribute to non-biodegradable waste by adding plastics and other materials to a cell phone that, if not recycled, may end up in landfills or other areas, and may have a negative environmental impact.

A typical screen protector may include a protective layer, such as a glass layer or a polymethyl methacrylate (PMMA) layer. The protective layer may be adhered to a mobile device screen by an adhesive or glue layer. In typical construction, a polyethylene terephthalate (PET) sub-layer may be incorporated within the adhesive or glue layer to provide a structural intermediary for adhering the protective layer to the screen.

However, the PET sub-layer within the adhesive layer may add mass to the screen protector and may not be environmentally friendly if the screen protector is exchanged for another and/or thrown away instead of recycled. Additionally, typical screen protectors may include other materials that are not environmentally friendly and/or not biodegradable, such as a cap sheet that may be peeled off and discarded when the screen protector is installed. Other disadvantages may exist.

### SUMMARY

Disclosed is an environmentally friendly screen protector for mobile devices. In an embodiment, a synthetic glass screen protector apparatus may include a PMMA layer. The apparatus may further include an A-B glue layer, where the A-B glue layer includes an optically clear adhesive sub-layer and a silicone adhesive sub-layer, and where the clear adhesive sub-layer is in direct contact with the silicone adhesive sub-layer.

In some embodiments, the apparatus includes a cap sheet positioned on the PMMA layer. In some embodiments, the cap sheet is configured to be removed during installation of the PMMA layer and the A-B glue layer on a mobile device screen. In some embodiments, the apparatus includes an anti-fingerprint material coating the PMMA layer. In some embodiments, the apparatus includes an anti-microbial material coating the PMMA layer. In some embodiments, the PMMA layer includes a first acrylic sub-layer, a PET sub-layer, and a second acrylic sublayer. In some embodiments, the A-B glue layer excludes a PET sub-layer. In some embodiments, the A-B glue layer is configured to adhere the PMMA layer to a screen of a mobile device. In some embodiments, the apparatus includes a backer positioned under the A-B glue layer. In some embodiments, the backer includes a biodegrading additive. In some embodiments, the backer is configured to be removed before installation of the PMMA layer and the A-B glue layer onto a mobile device screen.

In an embodiment, a synthetic glass screen protector apparatus includes a polymethyl methacrylate (PMMA) layer. The apparatus further includes an A-B glue layer that includes an optically clear adhesive sub-layer and a silicone adhesive sub-layer, where the A-B glue layer excludes a polyethylene terephthalate (PET) sub-layer between the optically clear adhesive sub-layer and the silicone adhesive sub-layer.

In some embodiments, the PMMA layer is less than 0.25 mm thick. In some embodiments, the A-B glue layer is less than 0.20 mm thick. In some embodiments, the apparatus includes a cap sheet positioned on the PMMA layer, and a backer positioned under the A-B glue layer.

In an embodiment, a method for forming a synthetic glass screen protector apparatus includes forming an A-B glue layer by positioning an optically clear adhesive sub-layer in direct contact with a silicone adhesive sub-layer. The method further includes attaching the A-B glue layer to a PMMA layer. In some embodiments, the method includes positioning a cap sheet on the PMMA layer and positioning a backer under the A-B glue layer.

### BRIEF DESCRIPTION OF THE DRAWINGS

FIG. 1 depicts an embodiment of a synthetic glass screen protector apparatus in the form of a stack-up of layers.

FIG. 2 depicts an embodiment of a synthetic glass screen protector attached to a mobile device.

FIG. 3 depicts an embodiment of a method for forming a synthetic glass screen protector.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure.

### DETAILED DESCRIPTION

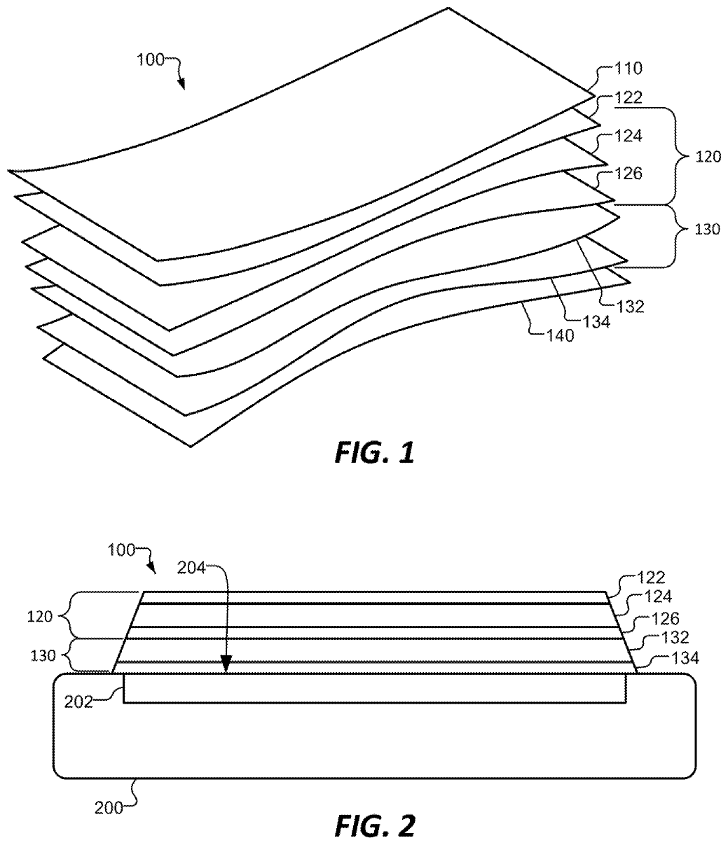

Referring to FIG. 1, an embodiment of a synthetic glass screen protector apparatus 100 is depicted in the form of a stack-up that includes multiple layers and sub-layers. For example, the apparatus 100 may include a cap sheet 110, a polymethyl methacrylate (PMMA) layer 120, an A-B glue layer 130, and a backer 140. The layers depicted in FIG. 1 are separated for clarity and may not be drawn to scale. The shape of the apparatus 100 from a plan view may be determined to fit a screen of a mobile device, such as a mobile phone, a tablet, a laptop, or another type of mobile computing device.

The cap sheet 110 may be positioned on the PMMA layer 120. During manufacture, shipment, and storage of the apparatus 100, the cap sheet 110 may protect the PMMA layer 120 from dust, debris, scratches, or other potential sources of damage. The cap sheet 110 may include polyethylene terephthalate (PET). However, in some cases, other materials may be used including recycled materials or additives to assist with biodegradability. The cap sheet 110 may be configured to be removed during or after installation of the apparatus 100, including the PMMA layer 120 and the A-B glue layer 130 onto a mobile device screen. The cap sheet 110 may have a thickness of about 0.1 mm. Other thicknesses are possible.

The PMMA layer 120 may include a first acrylic sub-layer 122, a PET sub-layer 124, and a second acrylic sublayer 126. The first acrylic sub-layer 122 may be positioned on the PET sub-layer 124 and may include an anti-fingerprint and/or anti-microbial material. The anti-fingerprint and/or anti-microbial material may take the form of a coating on the first acrylic sub-layer 122 or it may be incorporated into the first acrylic sub-layer 122 itself. For example, the first acrylic sub-layer 122 may be an anti-fingerprint and/or anti-microbial coating itself. The anti-fingerprint and/or anti-microbial material may be non-fluorine based. The first acrylic sub-layer 122 may provide a touch surface for the apparatus 100 when in use. For example, after removal of the cap sheet 110, a user may touch the first acrylic sub-layer 122 when interfacing with a touchscreen of a mobile device. The first acrylic sub-layer 122 may have a thickness of about 0.02 mm. Other thicknesses are possible.

The PET sub-layer 124 may be positioned on the second acrylic sub-layer 126 and may provide structural support for protecting a mobile device screen. The PET sub-layer 124 may be shatter-resistant and scratch resistant and may also provide most of the structural support for the apparatus 100. The PET sub-layer 124 may have a thickness of about 0.188 mm.

The second acrylic sub-layer 126 may be positioned on the A-B glue layer 130 and may function as a bonding liner to facilitate bonding between the PMMA layer 120 and the A-B glue layer 130. The second acrylic sub-layer 126 may have a thickness of about 0.002 mm. Other thicknesses are possible.

The A-B adhesive layer 130 may include an optically clear adhesive sub-layer 132 and a silicone adhesive sub-layer 134. The optically clear adhesive sub-layer 132 may include an A-B glue material for adhering the second acrylic sub-layer 126 of the PMMA layer 120 to the silicone adhesive layer 134. The A-B glue material may include a first component (referred to as component A) and a second component (referred to as component B). During manufacturing of the apparatus 100, the components A and B may be mixed and may chemically react. The reaction may cause polymers to cross-link between the components A and B, forming an adhesive bond that is transparent and optically clear. A thickness of the optically clear adhesive sub-layer 132 may be about 0.12 mm. Other thicknesses are possible.

The silicone adhesive layer 134 may be positioned on the backer 140 and may provide adhesive properties for adhering the apparatus 100, including the PMMA layer 120 and the A-B glue layer 130 onto a mobile device. In other words, the silicone adhesive layer 134 may adhere the A-B glue layer 130 to the mobile device and the A-B glue layer 130 may be adhered to the PMMA layer 120. The silicone adhesive layer 134 may have a thickness of about 0.04 mm. Other thicknesses are possible.

Typical screen protection apparatuses may include an additional layer of PET between an optically clear adhesive and a silicone adhesive. However, the additional layer of PET may add to the amount of plastic waste after the usable life of the mobile device to which the screen protection apparatus is attached. For this reason, the apparatus 100 may omit and exclude any PET layer or sub-layer between the optically clear adhesive sub-layer 132 and the silicone adhesive sub-layer 134. In some cases, the clear adhesive sub-layer 132 may be in direct contact with the silicone adhesive sub-layer 134. Thus, the apparatus 100 may be more environmentally friendly than other typical screen protection devices.

The backer 140 may protect and preserve the silicone adhesive sub-layer 134 during manufacture, shipment, and storage of the apparatus 100. During installation of the apparatus on a mobile device, the backer 140 may be removed to expose the silicone adhesive sub-layer 134 to a surface of the mobile device screen. The backer 140 may include polycarbonate (PC). However, in some cases, the backer 140 may be biodegradable. For example, the PC backer 140 may include other materials instead of PC and/or the backer 140 may include a biodegrading additive to increase the speed at which the PC within the backer 140 breaks down. The backer 140 may have a thickness of about 0.8 mm. Other thicknesses are possible.

Referring to FIG. 2, the apparatus 100 is depicted with its layers combined and installed onto a screen 202 of a mobile device 200. The proportions and sized of the apparatus 100 and the mobile device 200 depicted in FIG. 2 are adjusted for clarity. In practice, the proportions and sizes may be significantly different. For example, the apparatus 100 may be much thinner than depicted. Further, the apparatus 100 is depicted with a taper. In some applications, it may not include a taper, or may include one or more other manufacturing finishes.

As shown in FIG. 2, the cap sheet 110 and the backer 140 have been removed for installation on the mobile device 200. Thus, during use, the apparatus 100 may include the PMMA layer 120 and the A-B glue layer 130. The first acrylic sub-layer 122 may be exposed to enable touch screen interfacing with the screen 202 of the mobile device. As previously explained, the first acrylic sub-layer 122 may include an anti-fingerprint and/or anti-microbial material to facilitate touchscreen use. The anti-fingerprint and/or anti-microbial material may be non-fluorine based. By omitting fluorine from the first acrylic sub-layer 122, the apparatus 100 may be more environmentally friendly and reduce any health risks to a user.

The PET sub-layer 124 may provide structural support for the apparatus 100 and may provide protection for the screen 202. For example, as explained above, the PET sub-layer 124 may be shatter-resistant and scratch resistant. The second acrylic sub-layer 126 may function as a bonding liner to facilitate bonding between the PMMA layer 120 and the A-B glue layer 130.

As explained above, the A-B glue layer 130 may provide adherence between the PMMA layer 120 and the screen 202. In particular, the A-B glue layer 130 may include the optically clear adhesive sub-layer 132, which may comprise an A-B glue material, for adhering the PMMA layer 120 to the silicone adhesive sub-layer 134. The silicone adhesive sub-layer 134 may, in turn, adhere to apparatus 100 to the screen 202. In order to be environmentally friendly, the A-B glue layer 130 may omit any PET sub-layer between the optically clear adhesive sub-layer 132 and the silicone adhesive layer 134. Other advantages may exist.

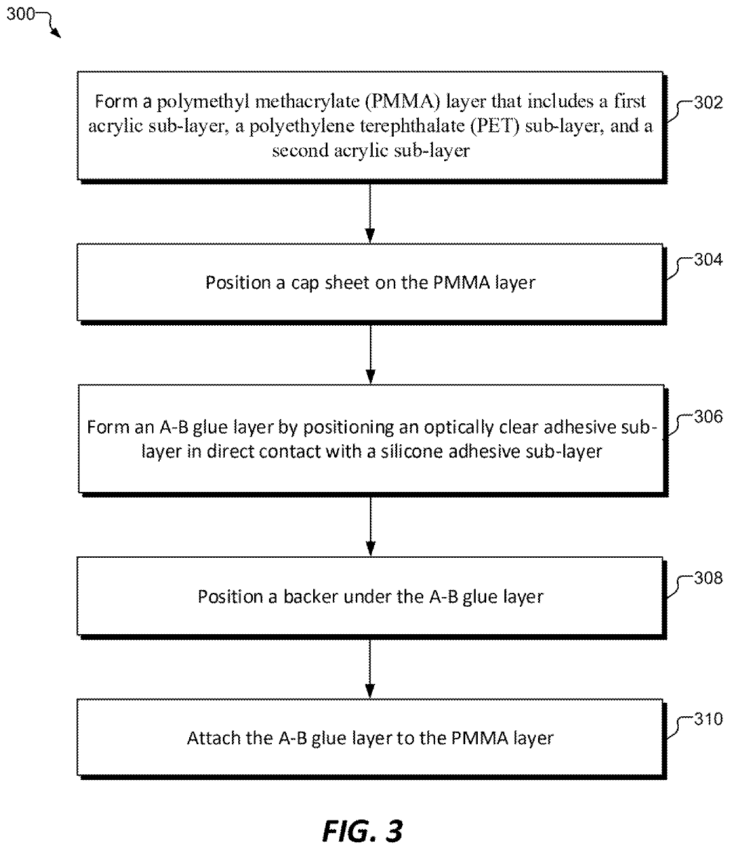

Referring to FIG. 3, a method 300 for forming a synthetic glass screen protector apparatus is depicted. The method 300 may include forming a PMMA layer that includes a first acrylic sub-layer, a PET sub-layer, and a second acrylic sub-layer, at 302. For example, the PMMA layer 120 may be formed and may include the first acrylic sub-layer 122, the PET sub-layer 124, and the second acrylic sub-layer 126.

The method 300 may further include positioning a cap sheet on the PMMA layer, at 304. For example, the cap sheet 110 may be positioned on the PMMA layer 120.

The method 300 may also include forming an A-B glue layer by positioning an optically clear adhesive sub-layer in direct contact with a silicone adhesive sub-layer, at 306. For example, the A-B glue layer 130 may be formed by positioned the optically clear adhesive sub-layer 132 in direct contact with the silicon adhesive sub-layer 134.

The method 300 may include positioning a backer under the A-B glue layer, at 308. For example, the PC baker 140 may be positioned under the A-B glue layer 130.

The method 300 may further include attaching the A-B glue layer to the PMMA layer, at 310. For example, the A-B glue layer 130 may be attached to the PMMA layer 120.

A benefit of the method 300 is that by placing the optically clear adhesive sub-layer in direct contact with the silicone adhesive sub-layer, without positioning any PET sub-layer between them, a synthetic glass screen protector apparatus may be produced while reducing the amount of plastics within the screen protector that could potentially become environmentally harmful waste. Other benefits may exist.

Although various embodiments have been shown and described, the present disclosure is not so limited and will be understood to include all such modifications and variations as would be apparent to one skilled in the art.

What is claimed is:

1. A synthetic glass screen protector apparatus comprising:
a polymethyl methacrylate (PMMA) layer; and
an A-B glue layer, wherein the A-B glue layer includes an optically clear adhesive sub-layer and a silicone adhesive sub-layer, and wherein the clear adhesive sub-layer is in direct contact with the silicone adhesive sub-layer.

2. The apparatus of claim 1, further comprising a cap sheet positioned on the PMMA layer.

3. The apparatus of claim 2, wherein the cap sheet is configured to be removed during installation of the PMMA layer and the A-B glue layer on a mobile device screen.

4. The apparatus of claim 1, further comprising an anti-fingerprint material coating the PMMA layer.

5. The apparatus of claim 1, further comprising an anti-microbial material coating the PMMA layer.

6. The apparatus of claim 1, wherein the PMMA layer includes a first acrylic sub-layer, a PET sub-layer, and a second acrylic sublayer.

7. The apparatus of claim 1, wherein the A-B glue layer excludes a PET sub-layer.

8. The apparatus of claim 1, wherein the A-B glue layer is configured to adhere the PMMA layer to a screen of a mobile device.

9. The apparatus of claim 1, further comprising a backer positioned under the A-B glue layer.

10. The apparatus of claim 9, wherein the backer includes a biodegrading additive.

11. The apparatus of claim 9, wherein the backer is configured to be removed before installation of the PMMA layer and the A-B glue layer onto a mobile device screen.

12. A synthetic glass screen protector apparatus comprising:
a polymethyl methacrylate (PMMA) layer; and
an A-B glue layer that includes an optically clear adhesive sub-layer and a silicone adhesive sub-layer, wherein the A-B glue layer excludes a polyethylene terephthalate (PET) sub-layer between the optically clear adhesive sub-layer and the silicone adhesive sub-layer.

13. The apparatus of claim 12, further comprising a material having anti-fingerprint properties, anti-microbial properties, or a combination thereof coating the PMMA layer.

14. The apparatus of claim 12, wherein the PMMA layer includes a first acrylic sub-layer, a PET sub-layer, and a second acrylic sublayer.

15. The apparatus of claim 12, wherein the clear adhesive sub-layer is in direct contact with the silicone adhesive sub-layer.

16. The apparatus of claim 12, wherein the PMMA layer is less than 0.25 mm thick.

17. The apparatus of claim 12, wherein the A-B glue layer is less than 0.20 mm thick.

18. The apparatus of claim 12, further comprising:
a cap sheet positioned on the PMMA layer; and
a backer positioned under the A-B glue layer.

19. A method for forming a synthetic glass screen protector apparatus comprising:
forming an A-B glue layer by positioning an optically clear adhesive sub-layer in direct contact with a silicone adhesive sub-layer; and
attaching the A-B glue layer to a polymethyl methacrylate (PMMA) layer.

20. The method of claim 19, further comprising:
positioning a cap sheet on the PMMA layer; and
positioning a backer under the A-B glue layer.
